(19) United States
(12) Patent Application Publication
(10) Pub. No.: US 2020/0234201 A1
(43) Pub. Date: Jul. 23, 2020

(54) ENVIRONMENTAL PREFERENCE BASED SEAT EXCHANGE PLATFORM

(71) Applicant: Carrier Corporation, Palm Beach Gardens, FL (US)

(72) Inventors: Luke Dorna, Roswell, GA (US); Dang Nguyen, Alpharetta, GA (US)

(21) Appl. No.: 16/632,067

(22) PCT Filed: Jul. 20, 2018
(86) PCT No.: PCT/US2018/043075

§ 371 Date: Jan. 17, 2020

Related U.S. Application Data
(60) Provisional application No. 62/534,943, filed on Jul. 20, 2017.

(51) Int. Cl. G06Q 10/02

(52) U.S. Cl. CPC G06Q 10/02

(57) ABSTRACT

A method of recommending a seat to a first user is provided. The method comprising: receiving environmental parameter preferences from a first user device; receiving environmental parameters for one or more seat locations, the one or more seat locations including a first seat location and a second seat location; determining one or more seat location recommendations in response to the environmental parameter preferences and the environmental parameters, the one or more seat location recommendations including a first seat location recommendation identifying the second seat location; and transmitting the one or more seat location recommendations to the first user device.

### BACKGROUND

The subject matter disclosed herein generally relates to the field of seating system, and more particularly to an apparatus and method of operating a seating system.

Existing seating systems are typically assigned manually by a human resources representative and do not allow much flexibility for users to seat where they desire.

### BRIEF SUMMARY

According to one embodiment, a method of recommending a seat to a first user is provided. The method comprising: receiving environmental parameter preferences from a first user device; receiving environmental parameters for one or more seat locations, the one or more seat locations including a first seat location and a second seat location; determining one or more seat location recommendations in response to the environmental parameter preferences and the environmental parameters, the one or more seat location recommendations including a first seat location recommendation identifying the second seat location; and transmitting the one or more seat location recommendations to the first user device.

In addition to one or more of the features described above, or as an alternative, further embodiments may include displaying the one or more seat location recommendations on the first user device when the first seat location recommendations are received.

In addition to one or more of the features described above, or as an alternative, further embodiments may include activating an alarm on the first user device when the one or more seat location recommendations are received.

In addition to one or more of the features described above, or as an alternative, further embodiments may include that prior to the transmitting, the method further comprises: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying the first seat location; and transmitting the seat location exchange proposal to the first device and the second device.

In addition to one or more of the features described above, or as an alternative, further embodiments may include that prior to the transmitting, the method further comprises: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying a third seat location; and transmitting the second seat location recommendation to the second user device.

In addition to one or more of the features described above, or as an alternative, further embodiments may include adjusting the one or more seat location recommendations in response to a seating restriction.

In addition to one or more of the features described above, or as an alternative, further embodiments may include receiving a seat location recommendation response from the first user device, the seat location recommendation response including a selection of the second seat location; and adjusting a component at the second seat location in response to the seat location recommendation response.

According to another embodiment, a seat management system is provided. The seat management system comprising: a processor; a memory comprising computer-executable instructions that, when executed by the processor, cause the processor to perform operations, the operations comprising: receiving environmental parameter preferences from a first user device; receiving environmental parameters for one or more seat locations, the one or more seat locations including a first seat location and a second seat location; determining one or more seat location recommendations in response to the environmental parameter preferences and the environmental parameters, the one or more seat location recommendations including a first seat location recommendation identifying the second seat location; and transmitting the one or more seat location recommendations to the first user device.

In addition to one or more of the features described above, or as an alternative, further embodiments may include that the operations further comprise: displaying the one or more seat location recommendations on the first user device when the one or more seat location recommendations are received.

In addition to one or more of the features described above, or as an alternative, further embodiments may include that the operations further comprise: activating an alarm on the first user device when the one or more seat location recommendations are received.

In addition to one or more of the features described above, or as an alternative, further embodiments may include that prior to the transmitting, the operations further comprises: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying the first seat location; and transmitting the seat location exchange proposal to the first device and the second device.

In addition to one or more of the features described above, or as an alternative, further embodiments may include that prior to the transmitting, the operations further comprise: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying a third seat location; and transmitting the second seat location recommendation to the second user device.

In addition to one or more of the features described above, or as an alternative, further embodiments may include that the operations further comprise: adjusting the one or more seat location recommendations in response to a seating restriction.

In addition to one or more of the features described above, or as an alternative, further embodiments may include that the operations further comprise: receiving a seat location recommendation response from the first user device, the seat location recommendation response including a selection of the second seat location; and adjusting a component at the second seat location in response to the seat location recommendation response.

According to another embodiment, a computer program product tangibly embodied on a computer readable medium is provided. The computer program product including instructions that, when executed by a processor, cause the processor to perform operations comprising: receiving environmental parameter preferences from a first user device; receiving environmental parameters for one or more seat locations, the one or more seat locations including a first seat location and a second seat location; determining one or more seat location recommendations in response to the environmental parameter preferences and the environmental parameters, the one or more seat location recommendations including a first seat location recommendation identifying the second seat location; and transmitting the one or more seat location recommendations to the first user device.

In addition to one or more of the features described above, or as an alternative, further embodiments may include that the operations further comprise: displaying the one or more seat location recommendations on the first user device when the one or more seat location recommendations are received.

In addition to one or more of the features described above, or as an alternative, further embodiments may include that the operations further comprise: activating an alarm on the first user device when the one or more seat location recommendations are received.

In addition to one or more of the features described above, or as an alternative, further embodiments may include that prior to the transmitting, the operations further comprises: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying the first seat location; and transmitting the seat location exchange proposal to the first device and the second device.

In addition to one or more of the features described above, or as an alternative, further embodiments may include that prior to the transmitting, the operations further comprise: checking whether the second seat location is occupied; determining that the second seat location is occupied by a second user of a second user device; receiving environmental parameter preferences from the second user device; determining a second seat location recommendation in response to the environmental parameter preferences of the second user device and the environmental parameters, the second seat location recommendation identifying a third seat location; and transmitting the second seat location recommendation to the second user device.

In addition to one or more of the features described above, or as an alternative, further embodiments may include that the operations further comprise: adjusting the one or more seat location recommendations in response to a seating restriction.

In addition to one or more of the features described above, or as an alternative, further embodiments may include that the operations further comprise: receiving a seat location recommendation response from the first user device, the seat location recommendation response including a selection of the second seat location; and adjusting a component at the second seat location in response to the seat location recommendation response.

Technical effects of embodiments of the present disclosure include a system to take into account user seat preferences and allocate seats among users in accordance with the preferences of each user.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

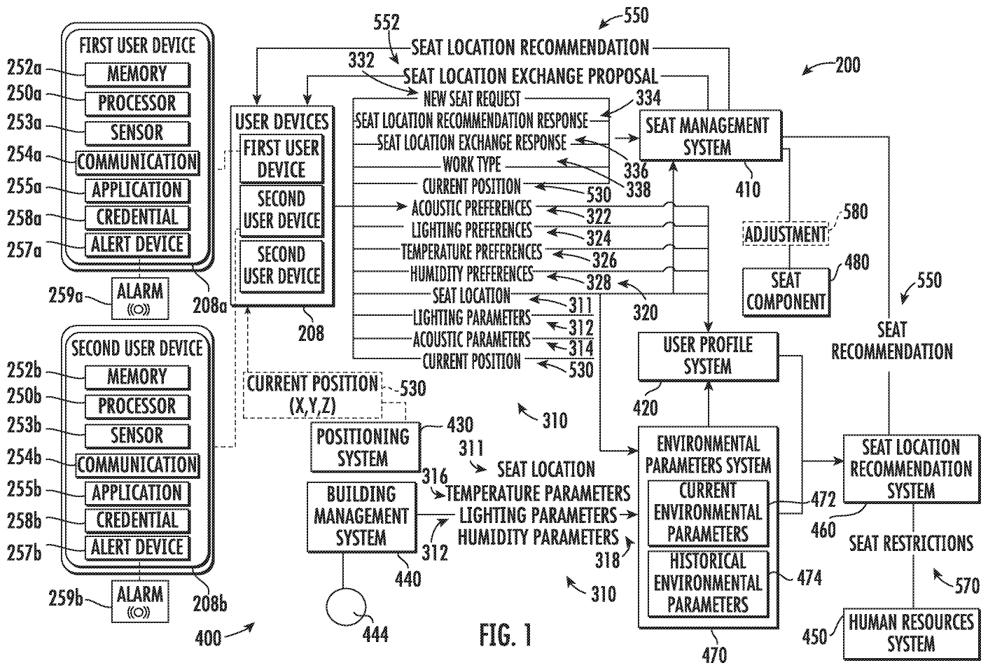

FIG. 1 illustrates a schematic view of a system, in accordance with an embodiment of the disclosure; and

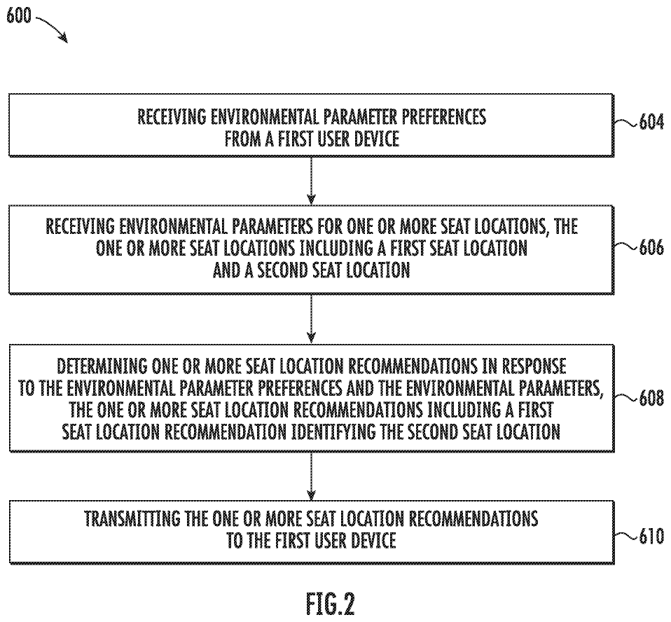

FIG. 2 is a flow diagram illustrating a method of recommending a seat location to a user, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 depicts a system 200 in an example embodiment. The system 200 includes a first user device 208a and a second user device 208b, however it is understood that the system 200 may include one or more user devices 208. The first user device 208a and the second user device 208b are capable of secure bi-directional communication with a plurality of interconnected systems 400, and each other.

The first user device 208a may be a computing device such as a desktop computer. The first user device 208a may also be a mobile computing device that is typically carried by a person, such as, for example a phone, PDA, smart watch, tablet, laptop, etc. The first user device 208a may also be two separate devices that are synced together such as, for example, a cellular phone and a desktop computer synced over an internet connection. The first user device 208a may include a processor 250a, memory 252a and communication module 254a as shown in FIG. 1. The processor 250a can be any type or combination of computer processors, such as a microprocessor, microcontroller, digital signal processor, application specific integrated circuit, programmable logic device, and/or field programmable gate array. The memory 252a is an example of a non-transitory computer readable storage medium tangibly embodied in the first user device 208a including executable instructions stored therein, for instance, as firmware. The communication module 254a may implement one or more communication protocols as described in further detail herein. The first user device 208a is configured to store a unique credential 258a that may be shared a plurality of interconnected systems 400, discussed further below. In a non-limiting example, the first user device 208a may belong to an employee and/or resident of a building. The first user device 208a may include an alert device 257a configured to activate an alarm 259a. In three non-limiting examples, the alert device 257a may be a vibration motor, audio speaker, and/or display screen. The alarm 259a may be audible, visual, haptic, and/or vibratory. The first user device 208a may also include one or more sensors 253a configured to detect environmental parameters 310 around the first user device 208a. Environmental parameters 310 may include but are not limited to lighting parameters 312, acoustic parameters 314, temperature parameters 316, and humidity parameters 318. The sensors 253a may utilize accelerometers and gyroscopes to track the motion and/or the location of the first user device 208a. The first user device 208a may also include a software application 255a. Embodiments disclosed herein, may operate through the software application 255a installed on the first user device 208a.

The second user device 208b may be a computing device such as a desktop computer. The second user device 208b may also be a mobile computing device that is typically carried by a person, such as, for example a phone, PDA, smart watch, tablet, laptop, etc. The second user device 208b may also be two separate devices that are synced together such as, for example, a cellular phone and a desktop computer synced over an internet connection. The second user device 208b may include a processor 250b, memory 252b and communication module 254b as shown in FIG. 1. The processor 250b can be any type or combination of computer processors, such as a microprocessor, microcontroller, digital signal processor, application specific integrated circuit, programmable logic device, and/or field programmable gate array. The memory 252b is an example of a non-transitory computer readable storage medium tangibly embodied in the second user device 208b including executable instructions stored therein, for instance, as firmware. The communication module 254b may implement one or more communication protocols as described in further detail herein. The second user device 208b is configured to store a unique credential 258b that may be shared with a plurality of interconnected systems 400, discussed further below. In a non-limiting example, the second user device 208b may belong to an employee and/or resident of the building. The second user device 208b may include an alert device 257b configured to activate an alarm 259b. In three non-limiting examples, the alert device 257b may be a vibration motor, audio speaker, and/or display screen. The alarm 259b may be audible, visual, haptic, and/or vibratory. The second user device 208b may also include one or more sensors 253b configured to detect environmental parameters 310 around the first user device 208a. The sensors 253b may utilize accelerometers and gyroscopes to track the motion and/or the location of the second user device 208b. Environmental parameters 310 may include but are not limited to lighting parameters 312, acoustic parameters 314, temperature parameters 316, and humidity parameters 318. The second user device 208b may also include an application 255b. Embodiments disclosed herein, may operate through the application 255b installed on the second user device 208b. It is understood that software operating application 255a and application 255b is the same software but is installed on two different devices including the first user device 208a and the second user device 208b.

As shown in FIG. 1, the system 200 also includes a plurality of interconnected systems 400 including: a seat management system 410, a user profile system 420, a positioning system 430, a building management system 440, a human resources system 450, a seat location recommendation system 460, an environmental parameter system 470, and a seat component 480. In the illustration of FIG. 1, the interconnected systems 400 are illustrated as separate systems. In an embodiment, at least one of the seat management system 410, the user profile system 420, the positioning system 430, the building management system 440, the human resources system 450, the seat location recommendation system 460, the environmental parameter system 470, and the seat component may be combined into a single system. In another embodiment, at least one of the seat management system 410, the user profile system 420, the positioning system 430, the building management system 440, the human resources system 450, the seat location recommendation system 460, and the environmental parameter system 470 may be incorporated in the application 255a on the first user device 208a. In another embodiment, at least one of the seat management system 410, the user profile system 420, the positioning system 430, the building management system 440, the human resources system 450, the seat location recommendation system 460, and the environmental parameter system 470 may be incorporated in the application 255b on the second user device 208b.

The interconnected systems 400 may each include a processor, memory, and communication module. For ease of illustration, the processor, memory, and communication module are not shown in FIG. 1. The processor can be any type or combination of computer processors, such as a microprocessor, microcontroller, digital signal processor, application specific integrated circuit, programmable logic device, and/or field programmable gate array. The memory is an example of a non-transitory computer readable storage medium tangibly embodied in or operably connected to the path determination system including executable instructions stored therein, for instance, as firmware. The communication module may implement one or more communication protocols as described in further detail herein.

The positioning system 430 is configured to determine the current position 530 of the first user device 208a and the second user devices 208b. The current position 530 of the first user device 208a may be referred to as the first current position 530 and the current position 530 of the second user device 208b may be referred to as the second current position 530. Each current position 530 may include the (x, y, z) coordinates of the first user device 208a and/or the second user devices 208b on a map. The (x, y, z) coordinates may translate to a latitude, a longitude, and an elevation, which may then be mapped to a seat location 311 within the building. Each current position 530 may include a mapped position inside and/or outside a building, such as, for example, a parking space, a test area, a building, a room, a floor, and/or a cubicle. A mapped position may be used for the current position 530 with the specific (x, y, z) coordinates are not available. For instance, the current position 530 may depict that a user is located on the 2^{nd} floor in conference room A. The seat location 311 may identify the building, the floor, the room, and/or the cubical where a seat may be located. A physical seat/workstation may not actually exist there but a current seating plan may be reconfigured to accommodate a seat at that location The positioning system 430 may use various methods in order to determine the current position 530 such as, for example, GPS, Bluetooth triangulation, Wi-Fi triangulation, cellular signal triangulation, or any other location determination method known to one of skill in the art. The positioning system 430 is configured to transmit the current position 530 to each of the user devices 208. Each user device 208 may be configured to assign a seat location 311 to each environmental parameter 310 detected in response to the current position 530 of the user device 208.

Environmental parameters 310 may also be detected by a building management system 440. The building management system 440 may include various environmental control systems such as, for example, a lighting system, an air conditioning system, a heating system, a humidification system, a dehumidification system, or any other environmental control system known to one of skill in the art. The building management system 440 may also include a plurality of sensors 444 to detect environmental parameters 310 both inside and outside a building at various seat locations 311. Each seat location 311 being a positional location of a workstation where a user may work. The building management system 440 and the user devices 208 communicate the environmental parameters 310 to the environmental parameters system 470. The environment parameter system 470 may store the environmental parameter 310 as current environmental parameters 472 for a selected period of time or until the environmental parameters 310 are updated with newer environmental parameters 310. Older environmental parameters 310 are then stored as historical environmental parameter 474 in the environmental parameter system 470 after newer environmental parameters 310 are received.

A user device 208 may submit environmental parameters preferences 320 to the user profile system 420. The user profile system 420 is configured to receive and store the environmental parameter preferences 320 from a user device 208 of each user. The environmental parameter preferences 320 may depict what environmental parameters 310 a user of a user device 208 may prefer. In a few non-limiting examples, a user may prefer a lot of acoustical noise or no noise, a user may prefer a lot of light or a little light, a user may prefer it hotter, or a user may prefer it colder. The environmental parameters 310 may include but are not limited to acoustic preferences 322, lighting preference 324, temperature preferences 326, and humidity preferences 328.

The seat location recommendation system 460 is configured to determine a seat location recommendation 550 in response to at least one of the environmental parameter preferences 320, the current environmental parameters 472, and the historical environmental parameters 474. The seat location recommendation system 460 may also factor in a work type 338 in the seat location recommendation 550 determination. The work type 338 may be transmitted from a user device 208 along with the new seat request 332 or may be included in the environmental parameter preferences 320 established by the user of a user device 208. The work type 338 may indicate the need for certain environmental parameters depending on whether user will be performing focused work or collaborative work. For example, if the work type 338 is focused work, the user may be seeking a quieter place, but if the work type 338 is group work, the user may be seeking louder more collaborative work environment. The environmental parameters preferences 320 of a user may be adjusted in response to the work type 338. The seat location recommendation system 460 may be in communication with a human resource system 450. The human resources system 450 may include seating restrictions 570. The seating restrictions 570 may limit where a person may sit and how often they may be able to move seats. For example, a person may not be able to sit in a certain area due to a security clearance or export clearance requirement. The seat location recommendation system 460 may adjust the seat location recommendation 550 in response to the seating restrictions 570. The seat location recommendation system 460 may determine a seat location recommendation 550 automatically or may be prompted to determine a seat location recommendation 550 by a move request 332. A user of a mobile device 208 may either approve or deny the seat location recommendation 550 by transmitting a seat location recommendation response 334. After a seat location recommendation 550 is approved, the seat management system 410 may transmit an adjustment command 580 to adjust a seat component 480 at the seat approved by the user. For example, the height of the desk may be adjusted, the height of the seat may be adjust, or a name tag may be adjust to match the new user.

The seat management system 460 may receive the seat location recommendation 550 and determine if the seat is already occupied or not. If the seat is already occupied, the seat location recommendation 550 may see if a seat exchange may be appropriate. If a seat exchange may be appropriate the seat management system 410 will transmit a seat exchange proposal 552. In an embodiment, the seat exchange proposal 552 may not be transmitting automatically but may be transmitted in response to a seat exchange request. A seat exchange may be appropriate if the environmental parameters 310 at a first seat location 311 of a first user match the environmental parameters preferences 320 at a second seat location 311 of a second user; and the environmental parameters 310 at the second seat location 311 match the environmental parameters preferences 320 of the first user. A user of a user device 208 may either approve or deny the seat exchange proposal 252 by transmitting a seat exchange response 336.

The first user device 208a and the second user device 208b communicate with the interconnected systems 400, and with each other via the software application 255a and 255b, respectively. The communication may occur over a wireless network, such as 802.11x (Wi-Fi), short-range radio (Bluetooth), cellular, satellite, etc. In some embodiments, an interconnected system 400 may include, or be associated with (e.g., communicatively coupled to) a networked system, such as kiosk, beacon, lantern, bridge, router, network node, building intercom system, etc. The networked system may communicate with the first user device 208a and the second user device 208b using one or more communication protocols or standards. For example, the networked system may communicate with the first user device 208a and the second user device 208b using near field communications (NFC). In an embodiment, the first user device 208a and the second user device 208b may communicate with an interconnected system 400 through a networked system. In other embodiments, the first user device 208a and the second user device 208b may establish communication with an interconnected system 400 that is not associated with a networked system in the building. This connection may be established with various technologies including GPS, 802.11x (Wi-Fi), cellular, or satellite, by way of non-limiting example. In example embodiments, the first user device 208a and the second user device 208b communicate over multiple independent wired and/or wireless networks. Embodiments are intended to cover a wide variety of types of communication between the first user device 208a, the second user device 208b, and the interconnected systems 400, thus embodiments are not limited to the examples provided in this disclosure.

Referring now to FIG. 2, with continued reference to FIG. 1. FIG. 2 shows a flow chart of method 600 of recommending a seat to a first user, in accordance with an embodiment of the disclosure. At block 604, environmental parameter preferences 320 are received from a first user device 208a. At block 606, environmental parameters 310 for one or more seat locations 311 are received. The one or more seat locations 311 may include a first seat location 311 and a second seat location 311. At block 608, one or more seat location recommendations 550 are determined in response to the environmental parameter preferences 320 and the environmental parameters 310. The one or more seat location recommendations 550 may be displayed as a list and/or a color coded map so that a user may explore all the available seat locations 311 prioritized by preference relevance, which may give the user an option to bypass a single recommendation based on a parameter outside of environmental parameter preferences 320 such as proximity to a colleague. The one or more seat location recommendations 550 may include a first seat location recommendation 550. The first seat location recommendation 550 identifies the second seat location 311. At block 610, the one or more seat location recommendations 550 are transmitted to the first user device 208a. The one or more seat location recommendations 550 may be displayed on the first user device 208a when the first seat location recommendation 550 is received. An alarm 259a may be activated on the first user device 208a when the one or more seat location recommendations 550 are received.

Prior to transmitting the one or more seat location recommendations 550, the seat management system 410 may check whether a seat in the one or more seat location recommendations 550 is occupied. Continuing the first seat location recommendation 550 example above, the seat management system 410 may check whether the second seat location 311 is occupied. If it is determined that the second seat location 311 is not occupied then the seat location recommendation 550 is transmitted to the first user device 208a. If it is determined that the second seat location 311 is occupied by a second user of a second user device 208b then the seat management system 410 may check whether a seat exchange is appropriate. To determine whether a seat exchange is appropriate, the seat management system 410 may receive environmental parameter preferences 310 from the second user device 208b and determine a second seat location recommendation 550 in response to the environmental parameter preferences 320 of the second user device 208b and the environmental parameters 310. If the second seat location recommendation 550 identifies the first seat location 311 of the first user device 208a then a seat exchange is appropriate and the seat management system 410 will transmit a seat exchange proposal 552 to the first device 208a and the second device 208b. If the second seat location recommendation 550 does not identify the first seat location 311 of the first user device 208a then a seat exchange may not be appropriate. Instead, the second seat location recommendation 550 may identify a third seat for the second user of the second user device 208b to move to and then the seat management system 410 may transmit the second seat location recommendation 550 to the second user device 208b in order to accommodate a move for the first user device 208a. As mentioned earlier, the seat location recommendations 550 may be adjusted in response to a seating restriction 570.

Further, the first user may either select a seat from the one or more seat location recommendations 550 by transmitting a seat location recommendation response 334 back to the seat management system 410. If the seat location recommendation response 334 selects a seat location recommendation 550 then the seat management system 410 may command an adjustment 580 of a seat component 480 at the selected seat location 311 in response to the seat location recommendation response 334. The adjustment may include adjusting the height of a chair and or a desk at a second seat location 311 to ergonomically fit the first user. The adjustment 580 may also include changing a name tag at the second seat location 311.

While the above description has described the flow process of FIG. 2 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of recommending a seat to a first user, the method comprising:
receiving environmental parameter preferences from a first user device;
receiving environmental parameters for one or more seat locations, the one or more seat locations including a first seat location and a second seat location;
determining one or more seat location recommendations in response to the environmental parameter preferences and the environmental parameters, the one or more seat location recommendations including a first seat location recommendation identifying the second seat location; and
transmitting the one or more seat location recommendations to the first user device.

2. The method of claim 1, further comprising:
displaying the one or more seat location recommendations on the first user device when the first seat location recommendations are received.

3. The method of claim 1, further comprising:
activating an alarm on the first user device when the one or more seat location recommendations are received.

4. The method of claim 1, wherein prior to the transmitting, the method further comprises:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying the first seat location; and
transmitting the seat location exchange proposal to the first device and the second device.

5. The method of claim 1, wherein prior to the transmitting, the method further comprises:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying a third seat location; and
transmitting the second seat location recommendation to the second user device.

6. The method of claim 1, further comprising:
adjusting the one or more seat location recommendations in response to a seating restriction.

7. The method of claim 1, further comprising:
receiving a seat location recommendation response from the first user device, the seat location recommendation response including a selection of the second seat location; and
adjusting a component at the second seat location in response to the seat location recommendation response.

8. A seat management system comprising:
a processor;
a memory comprising computer-executable instructions that, when executed by the processor, cause the processor to perform operations, the operations comprising:
receiving environmental parameter preferences from a first user device;
receiving environmental parameters for one or more seat locations, the one or more seat locations including a first seat location and a second seat location;
determining one or more seat location recommendations in response to the environmental parameter preferences and the environmental parameters, the one or more seat location recommendations including a first seat location recommendation identifying the second seat location; and
transmitting the one or more seat location recommendations to the first user device.

9. The seat management system of claim 8, wherein the operations further comprise:
displaying the one or more seat location recommendations on the first user device when the one or more seat location recommendations are received.

10. The seat management system of claim 8, wherein the operations further comprise:
activating an alarm on the first user device when the one or more seat location recommendations are received.

11. The seat management system of claim 8, wherein prior to the transmitting, the operations further comprises:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying the first seat location; and
transmitting the seat location exchange proposal to the first device and the second device.

12. The seat management system of claim 8, wherein prior to the transmitting, the operations further comprise:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying a third seat location; and
transmitting the second seat location recommendation to the second user device.

13. The seat management system of claim 8, wherein the operations further comprise:
adjusting the one or more seat location recommendations in response to a seating restriction.

14. The seat management system of claim 8, wherein the operations further comprise:
receiving a seat location recommendation response from the first user device, the seat location recommendation response including a selection of the second seat location; and
adjusting a component at the second seat location in response to the seat location recommendation response.

15. A computer program product tangibly embodied on a computer readable medium, the computer program product including instructions that, when executed by a processor, cause the processor to perform operations comprising:
receiving environmental parameter preferences from a first user device;
receiving environmental parameters for one or more seat locations, the one or more seat locations including a first seat location and a second seat location;
determining one or more seat location recommendations in response to the environmental parameter preferences and the environmental parameters, the one or more seat location recommendations including a first seat location recommendation identifying the second seat location; and
transmitting the one or more seat location recommendations to the first user device.

16. The computer program product of claim 15, wherein the operations further comprise:
displaying the one or more seat location recommendations on the first user device when the one or more seat location recommendations are received.

17. The computer program product of claim 15, wherein the operations further comprise:
activating an alarm on the first user device when the one or more seat location recommendations are received.

18. The computer program product of claim 15, wherein prior to the transmitting, the operations further comprises:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying the first seat location; and
transmitting the seat location exchange proposal to the first device and the second device.

19. The computer program product of claim 15, wherein prior to the transmitting, the operations further comprise:
checking whether the second seat location is occupied;
determining that the second seat location is occupied by a second user of a second user device;
receiving environmental parameter preferences from the second user device;
determining a second seat location recommendation in response to the environmental parameter preferences of the second user device and the environmental parameters, the second seat location recommendation identifying a third seat location; and
transmitting the second seat location recommendation to the second user device.

20. The computer program product of claim 15, wherein the operations further comprise:
adjusting the one or more seat location recommendations in response to a seating restriction.

21. (canceled)
